(19) United States
(12) Patent Application Publication
(10) Pub. No.: US 2012/0218280 A1
(43) Pub. Date: Aug. 30, 2012

(54) METHOD, APPARATUS AND SYSTEM FOR MODIFYING QUALITY OF AN IMAGE

(75) Inventor: Clement FREDEMBACH, Ultimo (AU)

(73) Assignee: CANON KABUSHIKI KAISHA, Tokyo (JP)

(21) Appl. No.: 13/399,601

(22) Filed: Feb. 17, 2012

(30) Foreign Application Priority Data
Feb. 25, 2011 (AU) 2011200830

(51) Int. Cl. G09G 5/00

(52) U.S. Cl. 345/581

(57) ABSTRACT

A method of modifying perceptual quality of an image is disclosed. For each of a plurality of predetermined attributes, distribution values are determined for that attribute. The distribution values are determined across the image. Compactness of the distribution values is determined for each of the attributes. The compactness is a measure of spatial localisation of the distribution values for the respective attribute. An attribute is selected from the plurality of predetermined attributes based on the determined compactness of the respective distribution values. The selected attribute is modified in a part of the image associated with spatially localised values, so as to modify the perceptual quality of the image. The image is stored, according to the modified attribute, in a computer readable storage medium.

### REFERENCE TO RELATED PATENT APPLICATION(S)

This application claims the benefit under 35 U.S.C. §119 of the filing date of Australian Patent Application No. 2011200830, filed 25 Feb. 2011, hereby incorporated by reference in its entirety as if fully set forth herein.

### FIELD OF INVENTION

The present invention relates to image enhancement and, in particular, to a method and apparatus for modifying perceptual quality of an image. The invention also relates to a computer program product including a computer readable medium having recorded thereon a computer program for modifying perceptual quality of an image.

### DESCRIPTION OF BACKGROUND ART

An image, digital or hardcopy, is only an imperfect representation of a scene, produced by a device whose accuracy is limited by its technical (e.g., optical, mechanical or electronic), capabilities. Should one be able to create an ideal, perfect imaging device, the images the device would produce would still not be optimal in a preferred, subjective sense. A device able to reproduce physical reality perfectly still does not take into account the major processing centre that is a human brain, in particular a visual cortex. In addition, humans compare images to their perception or memory of an original scene. Memory is imperfect and affected by preference.

As a result, it is rare that users require or even desire that an image be a perfect replica of reality. Instead, a preferred reproduction is what is being sought. Therefore, every image can be improved, in a preferred sense at least. Improving perceived (also called subjective) quality of an image is as old as pictorial art itself, and photography in particular. There are indeed few images that cannot be improved by altering their contrast, saturation, or colour balance. Improvements, enhancements, or image modification with the intent of providing a (more) preferred representation of the scene have traditionally followed two distinct paths, each one with inherent strengths and weaknesses.

Global modifications, modifications that affect all parts of an image, have been employed for a long time, as a means to alter the reality of a scene, usually related to nature of the light impinging on the scene or light-sensitive imaging elements. Methods of global contrast enhancement often use filters placed in front of a camera, or simulated in software, such as yellow or red filters to decrease the influence of haze and increase perceived contrast between sky, clouds, and distant scene elements. Methods to white balance an image are based on image statistics or user-interaction in order to normalise colour of scene illuminant. While capable of significant image improvement, the usefulness of global methods is generally limited either by the need for manual intervention, or the range of scenes to which the global methods can be applied. Indeed, when a scene statistic does not comply with assumptions of a method, a frequent occurrence, global modification methods can significantly decrease the perceived image quality.

Local modification methods, which affect one or more specific regions of an image, are by virtue of their greater precision more robust. In particular, local modification methods only attempt to modify parts of an image that fit with assumptions, thereby avoiding many of the pitfalls of global enhancement methods. However, increased precision is generally gained at the expense of versatility. Local modification methods are therefore highly specific and normally only apply a single correction or are targeted towards a particular use-case. One example of a conventional local modification method is sharpening or local contrast enhancement. For instance, a known local histogram equalisation method splits an image into several regions, each of the regions being subsequently analysed for their suitability to histogram enhancement or an adaptive Gaussian filtering. Another different conventional method is to parse an image for the presence of specific elements and then apply a predetermined modification. Portraiture is one example of such a parsing method.

Local image enhancement is difficult, and conventional methods either employ complete user interaction, as found in image editing software, or partial user interaction. Another local image enhancement method is to employ image segmentation as a facilitating pre-processing step. However, robust image segmentation is difficult.

Local image enhancement methods can work well when the image adheres to a canonical standard. However, since the local image enhancement are deterministic methods, significant failures can often occur. Thus, the methods are prone to generating unwanted artefacts and to decrease perceive image quality when a modification step is applied.

### SUMMARY OF THE INVENTION

It is an object of the present invention to substantially overcome, or at least ameliorate, one or more disadvantages of existing arrangements.

Disclosed are methods which seek to address the above problems by determining which aspect of an image is suitable to be modified in order to enhance the image. The disclosed methods modify image aspects that are already present, thereby removing the need for segmentation and minimising the risk of over-enhancing an image and generating visually unappealing artefacts.

According to one aspect of the present disclosure, there is provided a method of modifying perceptual quality of an image, said method comprising:

determining, for each of a plurality of predetermined attributes, distribution values for that attribute, the distribution values being determined from a spatial distribution of the attribute across the image;

determining compactness of the distribution values for each of the attributes, said compactness being a measure of spatial localisation of the distribution values for the respective attribute;

selecting an attribute from the plurality of predetermined attributes based on the determined compactness of the respective distribution values;

modifying the selected attribute in a part of the image, so as to modify the perceptual quality of the image; and

storing the image, according to the modified attribute, in a computer readable storage medium.

According to another aspect of the present disclosure, there is provided a system for modifying perceptual quality of an image, said system comprising:
a memory for storing data and a computer program;
a processor coupled to said memory for execution said computer program, said computer program comprising instructions for:
   determining, for each of a plurality of predetermined attributes, distribution values for that attribute, the distribution values being determined from a spatial distribution of the attribute across the image;
   determining compactness of the distribution values for each of the attributes, said compactness being a measure of spatial localisation of the distribution values for the respective attribute;
   selecting an attribute from the plurality of predetermined attributes based on the determined compactness of the respective distribution values;
   modifying the selected attribute in a part of the image, so as to modify the perceptual quality of the image; and
   storing the image, according to the modified attribute, in a computer readable storage medium.

According to still another aspect of the present disclosure there is provided an apparatus for modifying perceptual quality of an image, said apparatus comprising:

means for determining, for each of a plurality of predetermined attributes, distribution values for that attribute, the distribution values being determined from a spatial distribution of the attribute across the image;

means for determining compactness of the distribution values for each of the attributes, said compactness being a measure of spatial localisation of the distribution values for the respective attribute;

means for selecting an attribute from the plurality of predetermined attributes based on the determined compactness of the respective distribution values;

means for modifying the selected attribute in a part of the image, so as to modify the perceptual quality of the image; and

means for storing the image, according to the modified attribute, in a computer readable storage medium.

According to still another aspect of the present disclosure there is provided a computer readable storage medium having a program recorded there for modifying perceptual quality of an image, said program comprising:

code for determining, for each of a plurality of predetermined attributes, distribution values for that attribute, the distribution values being determined from a spatial distribution of the attribute across the image;

code for determining compactness of the distribution values for each of the attributes, said compactness being a measure of spatial localisation of the distribution values for the respective attribute;

code for selecting an attribute from the plurality of predetermined attributes based on the determined compactness of the respective distribution values;

code for modifying the selected attribute in a part of the image, so as to modify the perceptual quality of the image; and

code for storing the image, according to the modified attribute, in a computer readable storage medium.

Other aspects of the invention are also disclosed.

### BRIEF DESCRIPTION OF THE DRAWINGS

One or more embodiments of the invention will now be described with reference to the following drawings, in which:

FIG. 1 is a flow diagram showing a method of modifying perceptual quality of an image;

FIG. 2 shows potential value distributions of a key attribute in the image, where each distribution is associated with different compactness values;

FIG. 3 shows mappings of distribution values for modifying the value of a selected key attribute;

FIG. 4 shows an example image;

FIG. 5A, 5B, and 5C show the decomposition of the image of FIG. 4 in three key attributes;

FIG. 6 shows an image generated by modifying key attribute values of the image of FIG. 5C;

FIG. 7 is a flow diagram showing an alternative implementation of the method of FIG. 1;

FIG. 8A shows an example of a compositional filter;

FIG. 8B shows an example of a size filter;

FIG. 9A is a flow diagram showing another alternative implementation of the method of FIG. 1;

FIG. 9B is a flow diagram showing another alternative implementation of the method of FIG. 1;

FIG. 9C is a flow diagram showing another alternative implementation of the method of FIG. 1;

FIG. 9D is a flow diagram showing another alternative implementation of the method of FIG. 1;

FIG. 10 shows various asymmetric key attribute modification function curves; and

FIGS. 11A and 11B collectively form a schematic block diagram representation of an electronic device upon which described arrangements can be practised.

### DETAILED DESCRIPTION OF EMBODIMENTS OF THE INVENTION

Where reference is made in any one or more of the accompanying drawings to steps and/or features, which have the same reference numerals, those steps and/or features have for the purposes of this description the same function(s) or operation(s), unless the contrary intention appears.

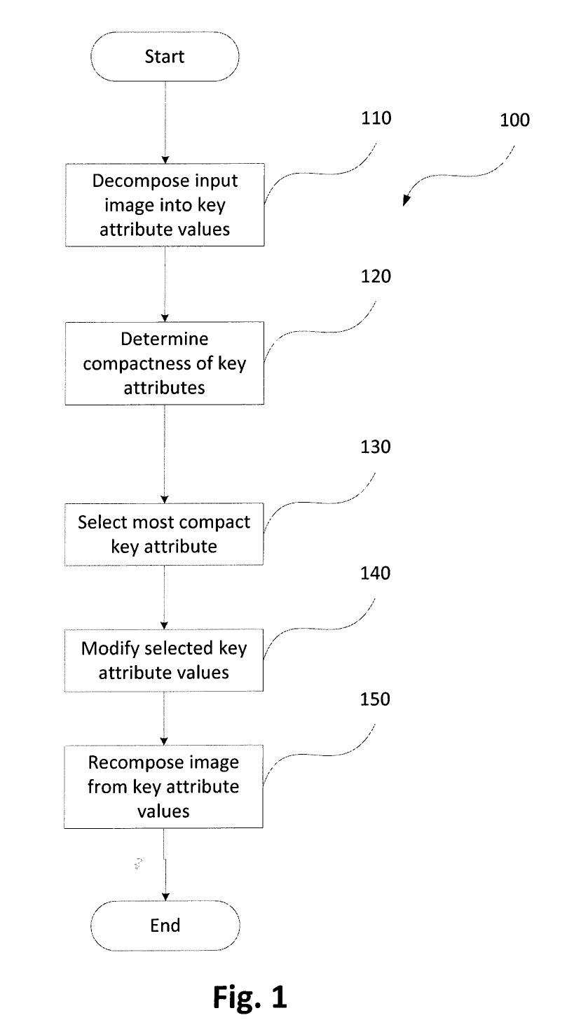

As described above, disclosed are methods which modify image aspects that are already present in an image, thereby removing the need for segmentation and minimising the risk of over-enhancing the image and generating visually unappealing artefacts. In particular, a method 100 of modifying perceptual quality of an image is described below with reference to FIG. 1. The described method 100 modifies images so that the images appear more pleasing to a majority of human observers. As described below, an input image is decomposed into a series of visually and perceptually meaningful “key attributes” (or key attribute values). A compactness value of spatial localisation of the key attribute is determined. One of the most compact key attributes is then selected and the values of the selected key attribute are modified so as to increase the compactness of the key attribute. Experimental results performed by the inventors indicate that a large majority of observers prefer images with high compactness.

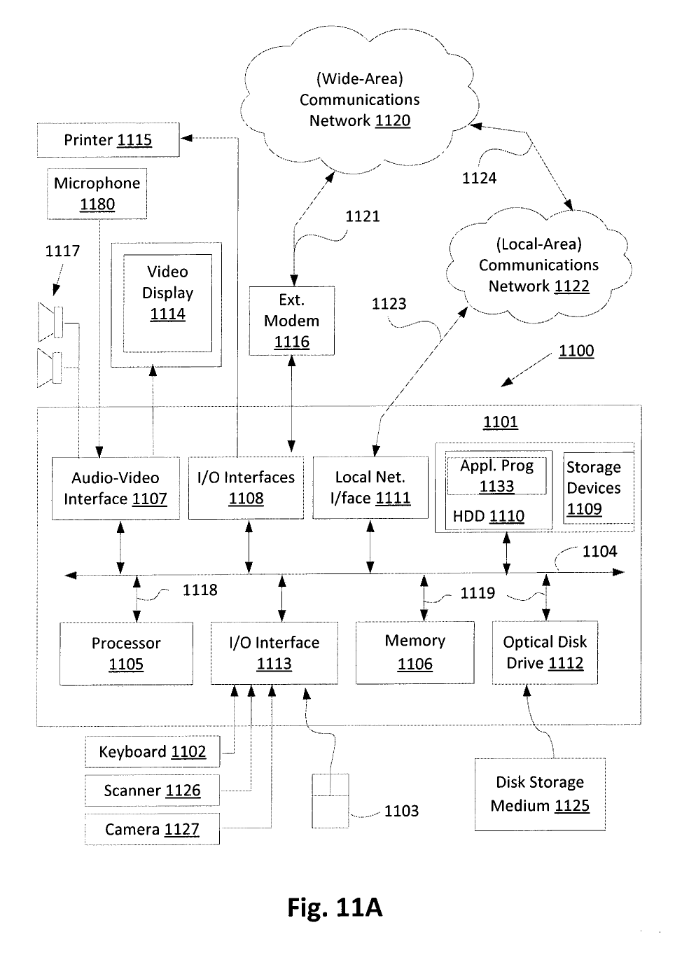

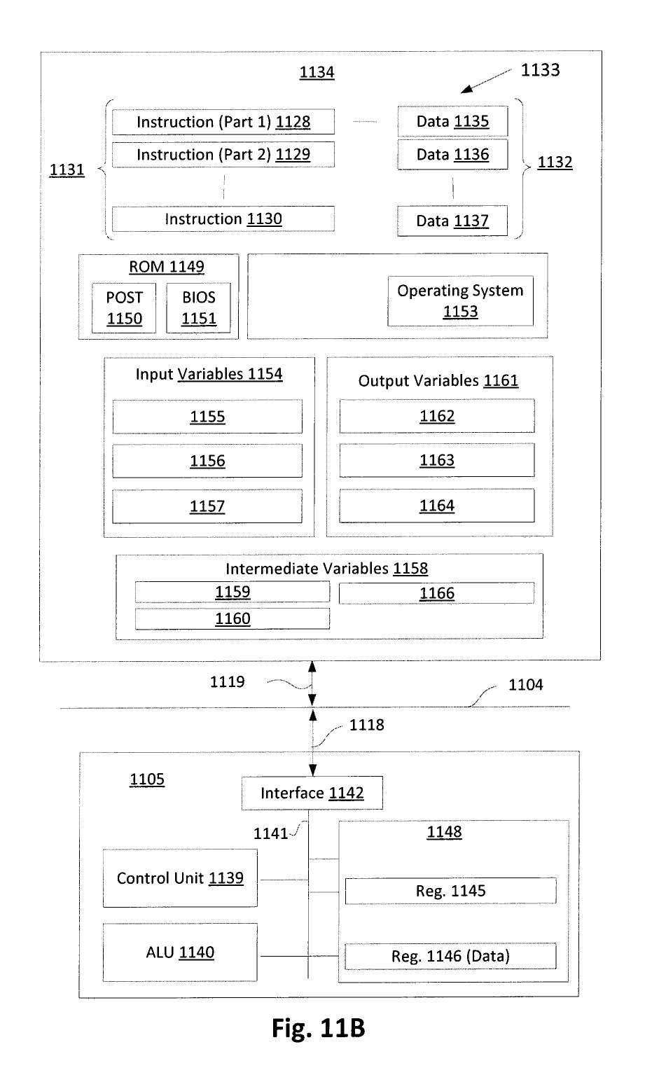

FIGS. 11A and 11B depict a general-purpose computer system 1100, upon which the described methods, including the method 100, may be practiced.

As seen in FIG. 11A, the computer system 1100 includes: a computer module 1101; input devices such as a keyboard 1102, a mouse pointer device 1103, a scanner 1126, a camera 1127, and a microphone 1180; and output devices including a printer 1115, a display device 1114 and loudspeakers 1117. An external Modulator-Demodulator (Modem) transceiver device 1116 may be used by the computer module 1101 for communicating to and from a communications network 1120 via a connection 1121. The communications network 1120 may be a wide-area network (WAN), such as the Internet, a cellular telecommunications network, or a private WAN. Where the connection 1121 is a telephone line, the modem 1116 may be a traditional “dial-up” modem. Alternatively, where the connection 1121 is a high capacity (e.g., cable) connection, the modem 1116 may be a broadband modem. A wireless modem may also be used for wireless connection to the communications network 1120.

The computer module 1101 typically includes at least one processor unit 1105, and a memory unit 1106. For example, the memory unit 1106 may have semiconductor random access memory (RAM) and semiconductor read only memory (ROM). The computer module 1101 also includes a number of input/output (I/O) interfaces including: an audio-video interface 1107 that couples to the video display 1114, loudspeakers 1117 and microphone 1180; an I/O interface 1113 that couples to the keyboard 1102, mouse 1103, scanner 1126, camera 1127 and optionally a joystick or other human interface device (not illustrated); and an interface 1108 for the external modem 1116 and printer 1115. In some implementations, the modem 1116 may be incorporated within the computer module 1101, for example within the interface 1108. The computer module 1101 also has a local network interface 1111, which permits coupling of the computer system 1100 via a connection 1123 to a local-area communications network 1122, known as a Local Area Network (LAN). As illustrated in FIG. 11A, the local communications network 1122 may also couple to the wide network 1120 via a connection 1124, which would typically include a so-called “firewall” device or device of similar functionality. The local network interface 1111 may comprise an Ethernet™ circuit card, a Bluetooth™ wireless arrangement or an IEEE 802.11 wireless arrangement; however, numerous other types of interfaces may be practiced for the interface 1111.

The I/O interfaces 1108 and 1113 may afford either or both of serial and parallel connectivity, the former typically being implemented according to the Universal Serial Bus (USB) standards and having corresponding USB connectors (not illustrated). Storage devices 1109 are provided and typically include a hard disk drive (HDD) 1110. Other storage devices such as a floppy disk drive and a magnetic tape drive (not illustrated) may also be used. An optical disk drive 1112 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 1100.

The components 1105 to 1113 of the computer module 1101 typically communicate via an interconnected bus 1104 and in a manner that results in a conventional mode of operation of the computer system 1100 known to those in the relevant art. For example, the processor 1105 is coupled to the system bus 1104 using a connection 1118. Likewise, the memory 1106 and optical disk drive 1112 are coupled to the system bus 1104 by connections 1119. Examples of computers on which the described arrangements can be practised include IBM-PC's and compatibles, Sun Sparcstations, Apple Mac™ or a like computer systems.

The described methods, including the method 100, may be implemented using the computer system 1100 wherein the processes of FIGS. 1 to 10, to be described, may be implemented as one or more software application programs 1133 executable within the computer system 1100. In particular, the steps of the described method 100 are effected by instructions 1131 (see FIG. 11B) in the software application program 1133 that are carried out within the computer system 1100. The software instructions 1131 may be formed as one or more software code modules, each for performing one or more particular tasks. The software application program 1133 may also be divided into two separate parts, in which a first part and the corresponding software code modules performs the described methods and a second part and the corresponding software code modules manage a user interface between the first part and the user.

The software application program 1133 may be stored in a computer readable medium, including the storage devices described below, for example. The software application program 1133 is loaded into the computer system 1100 from the computer readable medium, and is then executed by the computer system 1100. A computer readable medium having such software or computer program recorded on the computer readable medium is a computer program product. The use of the computer program product in the computer system 1100 preferably effects an advantageous apparatus for implementing the described methods.

The software application program 1133 is typically stored in the HDD 1110 or the memory 1106. The software application program 1133 is loaded into the computer system 1100 from a computer readable medium, and executed by the computer system 1100. Thus, for example, the software application program 1133 may be stored on an optically readable disk storage medium (e.g., CD-ROM) 1125 that is read by the optical disk drive 1112.

In some instances, the software application program 1133 may be supplied to the user encoded on one or more CD-ROMs 1125 and read via the corresponding drive 1112, or alternatively may be read by the user from the networks 1120 or 1122. Still further, the software application program 1133 can also be loaded into the computer system 1100 from other computer readable media. Computer readable storage media refers to any non-transitory tangible storage medium that provides recorded instructions and/or data to the computer system 1100 for execution and/or processing. Examples of such storage media include floppy disks, magnetic tape, CD-ROM, DVD, Blu-ray Disc, a hard disk drive, a ROM or integrated circuit, USB memory, a magneto-optical disk, or a computer readable card such as a PCMCIA card and the like, whether or not such devices are internal or external of the computer module 1101. Examples of transitory or non-tangible computer readable transmission media that may also participate in the provision of software, application programs, instructions and/or data to the computer module 1101 include radio or infra-red transmission channels as well as a network connection to another computer or networked device, and the Internet or Intranets including e-mail transmissions and information recorded on Websites and the like.

The second part of the software application program 1133 and the corresponding software code modules mentioned above may be executed to implement one or more graphical user interfaces (GUIs) to be rendered or otherwise represented upon the display 1114. Through manipulation of typically the keyboard 1102 and the mouse 1103, a user of the computer system 1100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 1117 and user voice commands input via the microphone 1180.

FIG. 11B is a detailed schematic block diagram of the processor 1105 and a “memory” 1134. The memory 1134 represents a logical aggregation of all the memory modules (including the HDD 1109 and semiconductor memory 1106) that can be accessed by the computer module 1101 in FIG. 11A.

When the computer module 1101 is initially powered up, a power-on self-test (POST) program 1150 executes. The POST program 1150 is typically stored in a ROM 1149 of the semiconductor memory 1106 of FIG. 11A. A hardware device such as the ROM 1149 storing software is sometimes referred to as firmware. The POST program 1150 examines hardware within the computer module 1101 to ensure proper functioning and typically checks the processor 1105, the memory 1134 (1109, 1106), and a basic input-output systems software (BIOS) module 1151, also typically stored in the ROM 1149, for correct operation. Once the POST program 1150 has run successfully, the BIOS 1151 activates the hard disk drive 1110 of FIG. 11A. Activation of the hard disk drive 1110 causes a bootstrap loader program 1152 that is resident on the hard disk drive 1110 to execute via the processor 1105. This loads an operating system 1153 into the RAM memory 1106, upon which the operating system 1153 commences operation. The operating system 1153 is a system level application, executable by the processor 1105, to fulfil various high level functions, including processor management, memory management, device management, storage management, software application interface, and generic user interface.

The operating system 1153 manages the memory 1134 (1109, 1106) to ensure that each process or application running on the computer module 1101 has sufficient memory in which to execute without colliding with memory allocated to another process. Furthermore, the different types of memory available in the system 1100 of FIG. 11A must be used properly so that each process can run effectively. Accordingly, the aggregated memory 1134 is not intended to illustrate how particular segments of memory are allocated (unless otherwise stated), but rather to provide a general view of the memory accessible by the computer system 1100 and how such is used. As shown in FIG. 11B, the processor 1105 includes a number of functional modules including a control unit 1139, an arithmetic logic unit (ALU) 1140, and a local or internal memory 1148, sometimes called a cache memory. The cache memory 1148 typically includes a number of storage registers 1144 - 1146 in a register section. One or more internal busses 1141 functionally interconnect these functional modules. The processor 1105 typically also has one or more interfaces 1142 for communicating with external devices via the system bus 1104, using a connection 1118. The memory 1134 is coupled to the bus 1104 using a connection 1119.

The software application program 1133 includes a sequence of instructions 1131 that may include conditional branch and loop instructions. The software application program 1133 may also include data 1132 which is used in execution of the program 1133. The instructions 1131 and the data 1132 are stored in memory locations 1128, 1129, 1130 and 1135, 1136, 1137, respectively. Depending upon the relative size of the instructions 1131 and the memory locations 1128-1130, a particular instruction may be stored in a single memory location as depicted by the instruction shown in the memory location 1130. Alternately, an instruction may be segmented into a number of parts each of which is stored in a separate memory location, as depicted by the instruction segments shown in the memory locations 1128 and 1129.

In general, the processor 1105 is given a set of instructions which are executed therein. The processor 1105 waits for a subsequent input, to which the processor 1105 reacts to by executing another set of instructions. Each input may be provided from one or more of a number of sources, including data generated by one or more of the input devices 1102, 1103, data received from an external source across one of the networks 1120, 1102, data retrieved from one of the storage devices 1106, 1109 or data retrieved from a storage medium 1125 inserted into the corresponding reader 1112, all depicted in FIG. 11A. The execution of a set of the instructions may in some cases result in output of data. Execution may also involve storing data or variables to the memory 1134.

The described methods use input variables 1154, which are stored in the memory 1134 in corresponding memory locations 1155, 1156, 1157. The methods produce output variables 1161, which are stored in the memory 1134 in corresponding memory locations 1162, 1163, 1164. Intermediate variables 1158 may be stored in memory locations 1159, 1160, 1166 and 1167.

Referring to the processor 1105 of FIG. 11B, the registers 1144, 1145, 1146, the arithmetic logic unit (ALU) 1140, and the control unit 1139 work together to perform sequences of micro-operations needed to perform “fetch, decode, and execute” cycles for every instruction in the instruction set making up the program 1133. Each fetch, decode, and execute cycle comprises:
(a) a fetch operation, which fetches or reads an instruction 1131 from a memory location 1128, 1129, 1130;
(b) a decode operation in which the control unit 1139 determines which instruction has been fetched; and
(c) an execute operation in which the control unit 1139 and/or the ALU 1140 execute the instruction.

Thereafter, a further fetch, decode, and execute cycle for the next instruction may be executed. Similarly, a store cycle may be performed by which the control unit 1139 stores or writes a value to a memory location 1132.

Each step or sub-process in the processes of FIGS. 1 to 10 is associated with one or more segments of the software application program 1133 and is performed by the register section 1144, 1145, 1147, the ALU 1140, and the control unit 1139 in the processor 1105 working together to perform the fetch, decode, and execute cycles for every instruction in the instruction set for the noted segments of the software application program 1133.

The method 100 may alternatively be implemented in dedicated hardware such as one or more integrated circuits performing the functions or sub functions of the method 100. Such dedicated hardware may include graphic processors, digital signal processors, or one or more microprocessors and associated memories.

The method 100 of modifying perceptual quality of an image will now be described with reference to FIG. 1. The method 100 may be implemented as one of more software code modules of the software application program 1133 resident on the hard disk drive 1110 and being controlled in its execution by the processor 1105.

The method 100 processes an input image formed by the camera 1127, for example. The output of the method 100 is an image which may be displayed on the display device 1114 or printed using the printer 1115. The input and output images of the method 100 may be tri-channel, RGB (i.e., encoded according to the RGB colour model), or images encoded in a standard colour space such as ISO sRGB (i.e., the International Organization for Standardization standard RGB colour space). Any input image may be converted to such a colourspace, regardless of the original encoding of the input image. The input image may be stored in the memory 1106 encoded in accordance with a particular colour space, such as sRGB, CIELab (i.e., the Commission Internationale de I'Eclairage 1976 L* a* b* colour space), HSV (i.e., the “Hue Saturation Value” colour space), or IPT (i.e., the “IPT Euclidean” colour space).

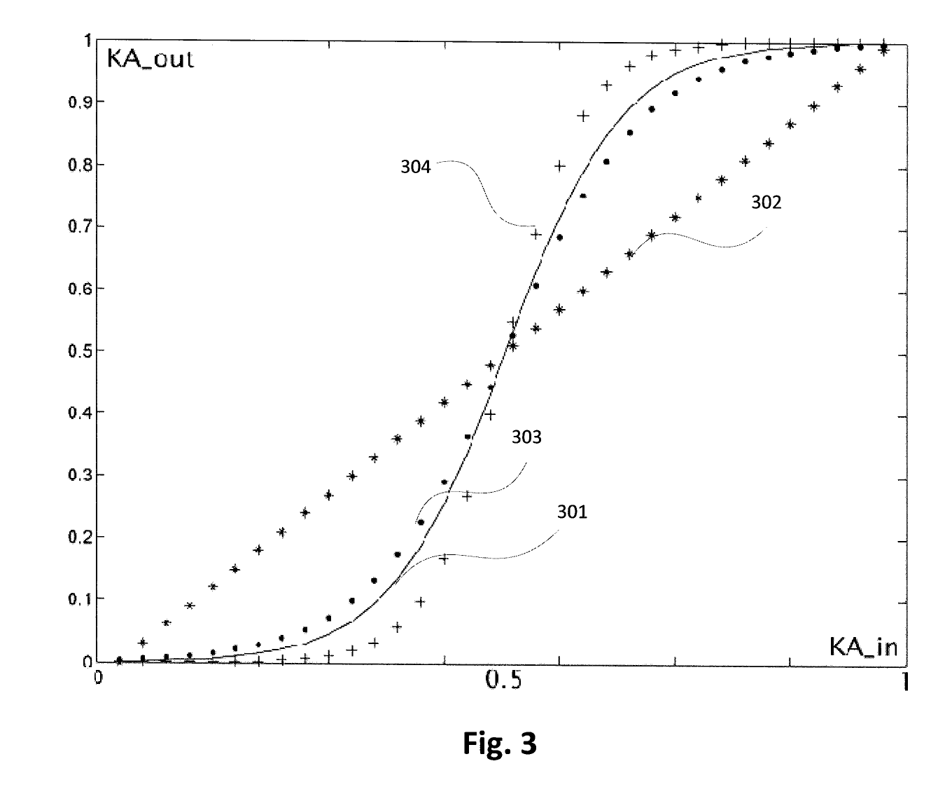

In decomposition step 110, the processor 1105 decomposes the input image into a number of predetermined key attribute (KA). Each of the key attributes has one or more associated key attribute values which may be stored in the memory 1106. The key attributes are properties of the input image that have a visual significance. Typical categories of key attributes include: Low-level features such as Red, Green, Blue, CIE L, CIE a and CIE b, (i.e., chromatic or brightness information); spatial features (e.g., texture, sharpness, contrast); or semantic features (e.g., the presence of a person or a face in the image). As will be described below with reference to FIG. 3, also at step 110, the processor 1105 may perform the step of determining, for each of the plurality of predetermined key attributes, a distribution map of values for that key attribute. The distribution values for the map are determined across the input image.

The decomposition performed at step 110 involves processing the input image by transforming the encoding of the input image using a suitable transformation. For example, the processor 1105 may transform the input image from sRGB to a perceptual colour space (e.g., CIELab, HSV, or IPT), or to another colour space, (e.g., Adobe™ RGB or XYZ). Furthermore, at step 110, the processor 1105 identifies semantic features (e.g., face, car, or sky detector) in the input image. The processor 1105 may also process the input image at step 110 in order to make some characteristics of the image visible (e.g., contrast, sharpness, blur).

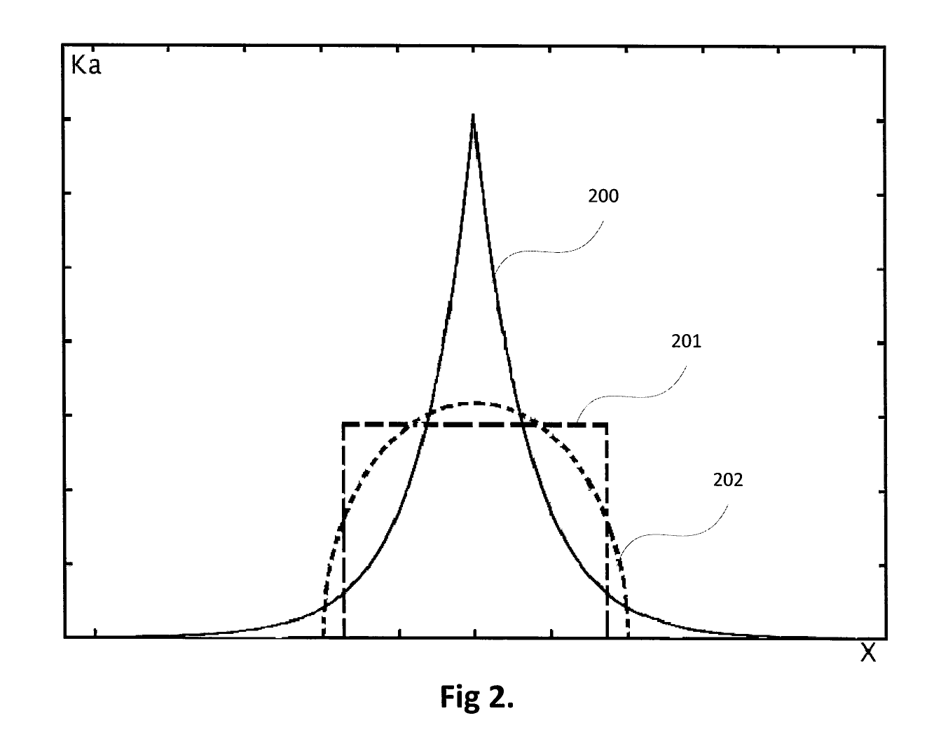

The key attributes into which the input image is decomposed are predetermined and may include at least the following: lightness, brightness (e.g., the L channel of Lab or the Y channel of XYZ); opponent Hue axes (e.g., a or b channels of Lab), or any diametric axis of the hue circle; local contrast and sharpness; and semantic descriptors, such as faces, obtained using any suitable face detection method. For example, the face detection method disclosed in the article by Viola and Jones, entitled “Robust real-time face detection”, International Journal of Computer Vision, 2004 may be used at step 110.At compactness determination step 120, the processor 1105 performs the step of determining compactness of each of the key attributes. The compactness is a measure of spatial localisation of the distribution values for the respective key attribute. In particular, for each of the key attributes determined at step 110, a measure of compactness of the spatial localisation of the key attribute values is determined. In step 120, the values of the selected key attribute are linearly transformed between zero (0) and one (1) and treated as a two dimensional (2D) probability distribution by normalising each key attribute such that the sum of the values of the key attribute equals one (1). FIG. 2 is a graph showing one dimensional (1D) key attribute value distributions 200, 201 and 202, where each distribution 200, 201 and 202 is associated with different compactness values. As seen in FIG. 2, one dimensional key attribute value distributions 200, 201 and 202 vary depending on the compactness values. As described herein, compactness is determined as the inverse of the “kurtosis” (or “peakedness”) of the two dimensional (2D) distribute associated with every key attribute. Kurtosis is a measure of concentration of a probability distribution. The higher the kurtosis (or peakedness), the heavier the tails of the associated probability distribution. A key attribute value distribution may be considered as compact when no tails are present in the distribution, such as a piecewise continuous (e.g., distribution 202), box function (e.g., the distribution 201), where Kurtosis is minimal

Other methods of determining compactness may also be used at step 120. For example, information theoretic entropy, which is the measure of uncertainty associated with a random variable, will increase together with spread, or uniformity, of the distribution of a random variable. Minimum entropy thus is a measure of compactness. Geometrical methods of clustering may also be used to measure the compactness of the spatial localisation associated with random variables.

At key attribute selection step 130, the processor 1105 performs the step of selecting an attribute from the plurality of predetermined key attributes based on the determined compactness of the respective distribution values for each key attribute. In particular, among the predetermined key attribute, a most compact key attribute for modifying the input image is selected by the processor 1105. By selecting a compact attribute the processor 1105 effectively selects a key attribute that is distinctive of a background of the input image. The present inventors determined that observers prefer images that have marked differences between a salient object of interest and a corresponding background. Selecting a key attribute that expresses that difference well permits a user to increase that difference. Increasing the difference between a salient object of interest and a corresponding background in the input image, improves the perceived quality of the image. An additional advantage of such a selection is contained in the intrinsic image adaptability of the method 100 because, given an image, the selected key attributes are the attributes that best express the background/object of interest separation. Therefore, step 130 of the method 100 provides a much more striking modification while preserving the visual properties of the original input image.

The method 100 continues at modification step 140, where the processor 1105 performs the step of modifying the selected attribute in a part of the input image associated with spatially localised values, so as to modify the perceptual quality of the image. In particular, the processor 1105 modifies the values of the selected key attribute, improving the perceived quality of the input image. The modification is performed at step 140 by mapping input values of the selected key attribute (KA) to a desired output, according to a particular mapping function. As described in detail below, in one or more implementations, the values of the selected key attribute may be modified at step 140 by:
(i) increasing the value of the selected attribute in areas of the input image where the selected attribute is compact; and/or
(ii) decreasing the value of the selected attribute in areas of the input image where the selected attribute is not compact.

Also at step 140, the processor 1105 may perform the step of storing the input image according to the modified key attribute. The input image may be stored in a computer readable medium in the form of the memory 1106.

FIG. 3 shows various distribution value mappings 301, 302, 303 and 304 that can be applied to the values of the selected key attribute at step 140. Each of the mappings 301, 302, 303 and 304 has a different associated mapping function. Values of the selected key attribute at both ends of the spectrum are preferably not clipped, as reflected in the mapping functions of FIG. 3. In one implementation, an s-shaped curve defined by KAout=1/(1+exp(n((KAin*a)-b)) is selected as the mapping function for modifying the values of the selected key attribute at step 140. The s-shaped curve is selected considering that the key attributes are determined as distributions whose values are between zero (0) and one (1). In one implementation the method 100 uses n=0.55, a=20 and b=10 for the s-shaped curve described above.

The method 100 concludes at recomposition step 150, where the processor 1105 recomposes the modified key attribute values stored in the memory 1106 into the original image encoding space, to generate a modified, enhanced image. In particular, at step 150, the processor 1105 may apply the inverse transformation to the transformation used in decomposition step 110, to the modified key attribute values stored in the memory 1106 at step 140. Thus, the method 100 outputs a modified, enhanced image in the same colour encoding space as the original input image was encoded, in order for the enhanced image to be displayed on the display 1114 or printed on the printer 1115. The modified, enhanced image may be stored in the memory 1106.

The method 100, by virtue of selecting only relevant key attributes and modifying the values of the key attributes augments the perceived saliency of the input image as well as quality of the image. In addition to observer preference mentioned above, the steps of the method 100 modify values of key attributes that already exhibit differences instead of trying to fit every image or region with a predetermined modification. Modifying values of the key attributes that are significant for the input image means that a greater visible effect may be achieved with a smaller modification. The method 100 reduces potential artefacts and decreases the chances of over-modifying the input image, which is a common problem of image enhancement methods. In addition, by enhancing a difference that already exists, the problems of edge-finding and matting common to most image enhancement methods become irrelevant, again saving processing time and minimising enhancement artefacts.

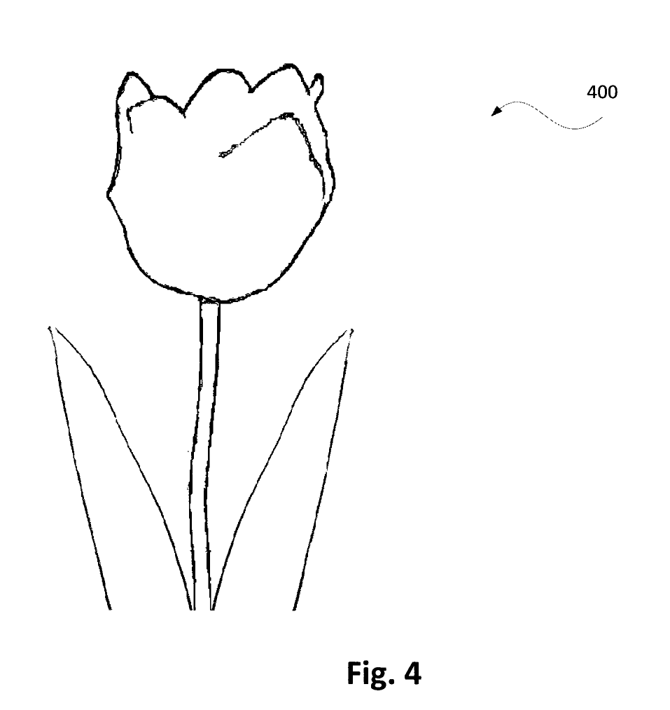

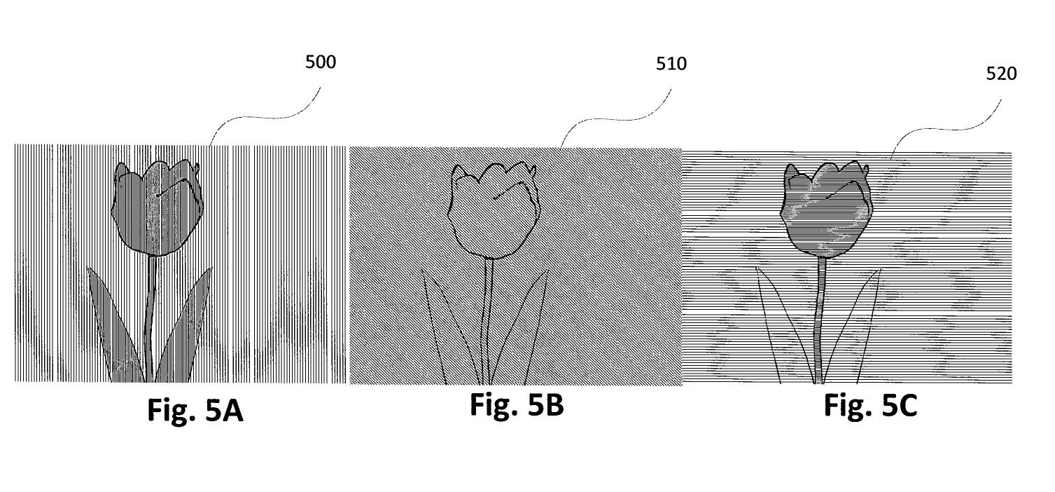

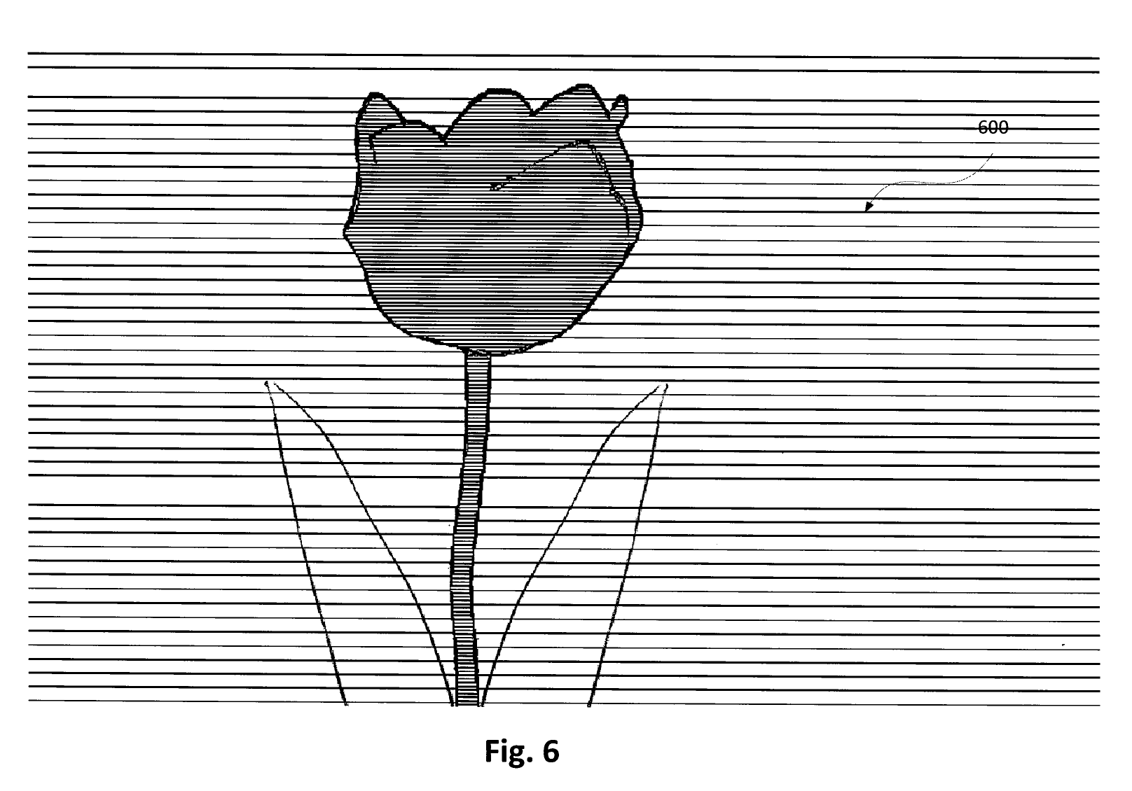

The method 100 will now be further described by way of example with reference to FIGS. 4 to 6. FIG. 4 shows an input image 400 that, for purpose of the illustration, has been reduced to a line drawing. FIGS. 5A, 5B and 5C show the decomposition of the image 400 into three (3) key attributes. In particular, FIG. 5A shows the image 400 decomposed into the CIE “L” attribute to form a decomposed image 500, as at step 110 of the method 100. Similarly, FIG. 5B shows the image 400 decomposed into the CIE “a” attribute to form a decomposed image 510. Further, FIG. 5C shows the image 400 decomposed into the CIE “b” attribute to form a decomposed image 520. The density of lines in each region of the images 500, 510 and 520 is proportional to the values of the key attributes of each of the images 500, 510 and 520. The density of the lines in each region of the images 500, 510 and 520 indicate that the key attribute (KA) (i.e., CIE b) of the image 520 is the most compact key attribute and so the CIE b attribute values of the image 520 are modified, as at step 140 of the method 100. FIG. 6 shows a modified, enhanced output image 600 generated by modifying the CIE b attribute values of the image 520, as at step 140 of the method 100.

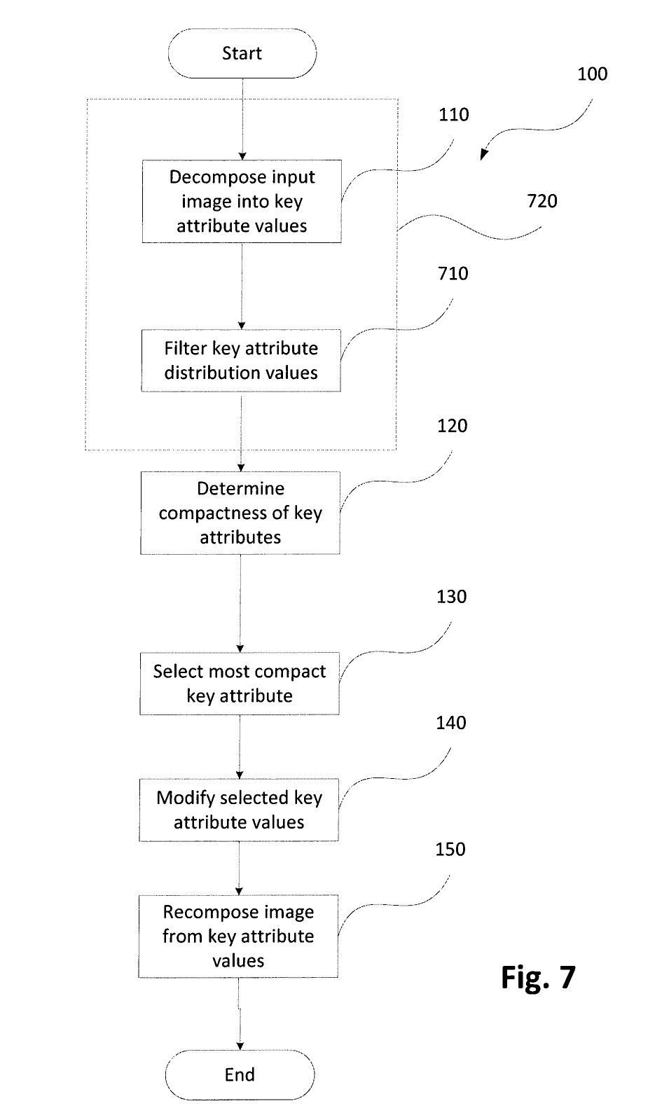

As shown in FIG. 7, in an alternative implementation, a filtering step 710 may be added between the decomposition step 110 and the compactness determination step 120. The steps 110 and 710 may be grouped as a decomposition-filtering step 720 as seen in FIG. 7.

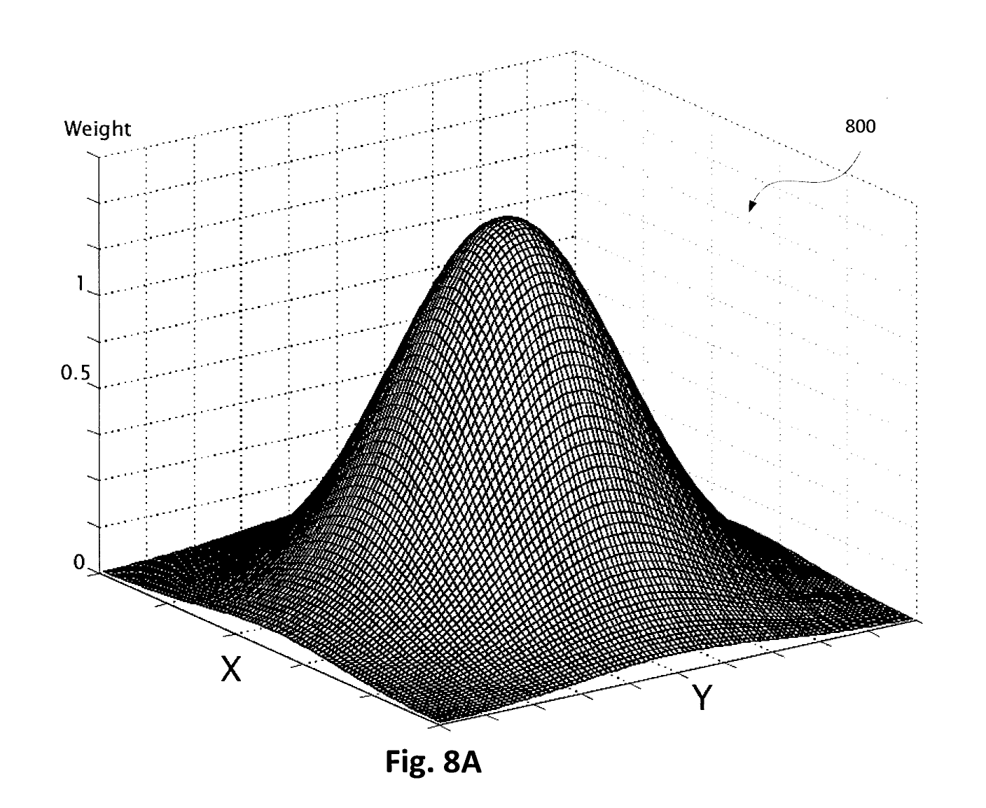

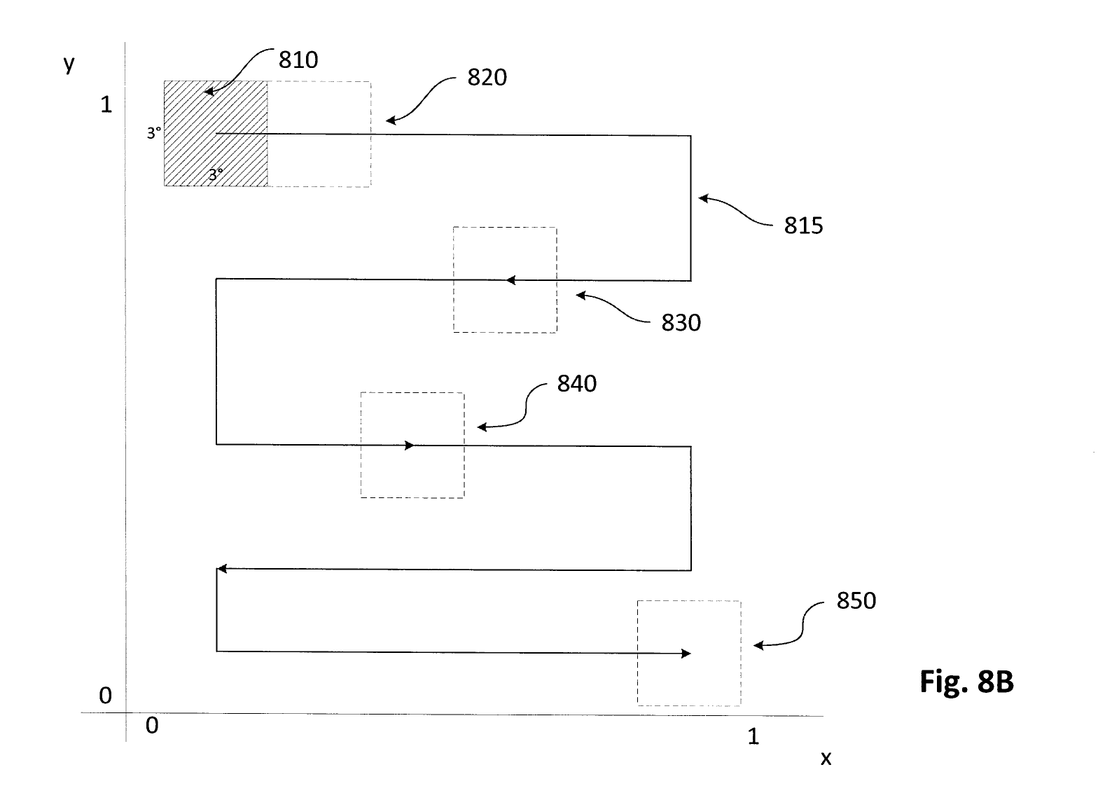

Salient objects of interest in images are not uniformly spatially distributed. In effect, there is a compositional bias, typically either following the photographic rule-of-thirds or, frequently for amateur photographers, a tendency to place objects of interest in the centre of the image. The compositional bias may be measured, for a category of images or a category of observers. The bias may be used as a means to refine the key attribute selection (as at step 130 of the method 100) by filtering the key attribute distribution values associated with each of the key attributes by location. In particular, the key attribute distribution values may be filtered with a composition filter at step 710, giving more weight to key attribute distribution values that are spatially located closer to a canonical compositional standard. Such a composition filter 800 is shown in FIG. 8A. Using the filter 800 of FIG. 8A at step 710, key attribute distribution values closer to the centre of the input image are given more weight.

The key attribute distribution values may also be filtered by size. In particular, objects of a particular size attract attention more readily. For instance, in a group shot, people's faces are of interest, while in a close-up portrait, elements such as eyes have a greater importance. Objects whose size subtend 2-5 degrees of visual angle have a greater impact. As such, the key attribute values determined at step 110 may be filtered with a size-prior filter that gives more weight to a region of a given size, such as filter 810 shown in FIG. 8B. Filtering the image in such a manner is advantageous as the filtering diminishes the importance of noise in the selection of the key attribute (KA) to be modified, as at step 130 of the method 100. In one implementation, as seen in FIG. 8B, a square filter 810 of size corresponding to three (3) degrees of subtended visual angle may be used at step 710 of the method 100. The filter 810 is composed of ones. The filter 810 is moved over a decomposed image (e.g., 500) by one pixel along a raster-type path 815 to reach intermediate positions (e.g., 820, 830, 840) before reaching final position 850 having been moved over the entire image (e.g., 500).

The filter 810 gives greater weight to compact and distinct regions of the input image that are of the size of the filter 810. As described above, FIG. 8B shows one example of how such a filter may be used, although it will be appreciated that any suitable 2-dimensional filtering method may alternatively be used at step 710 of the method 100.

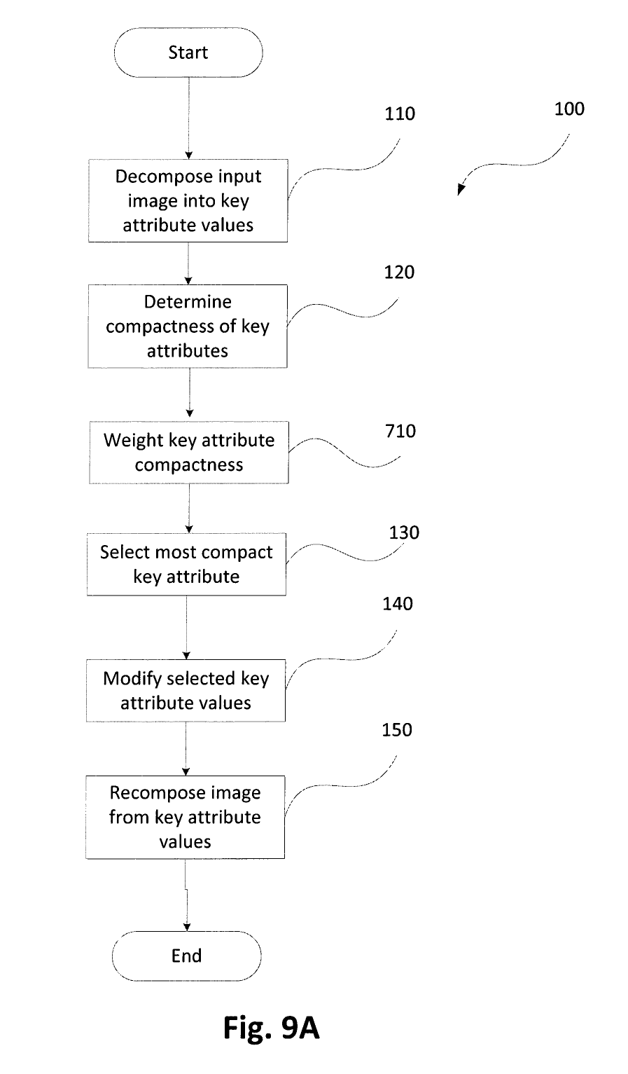

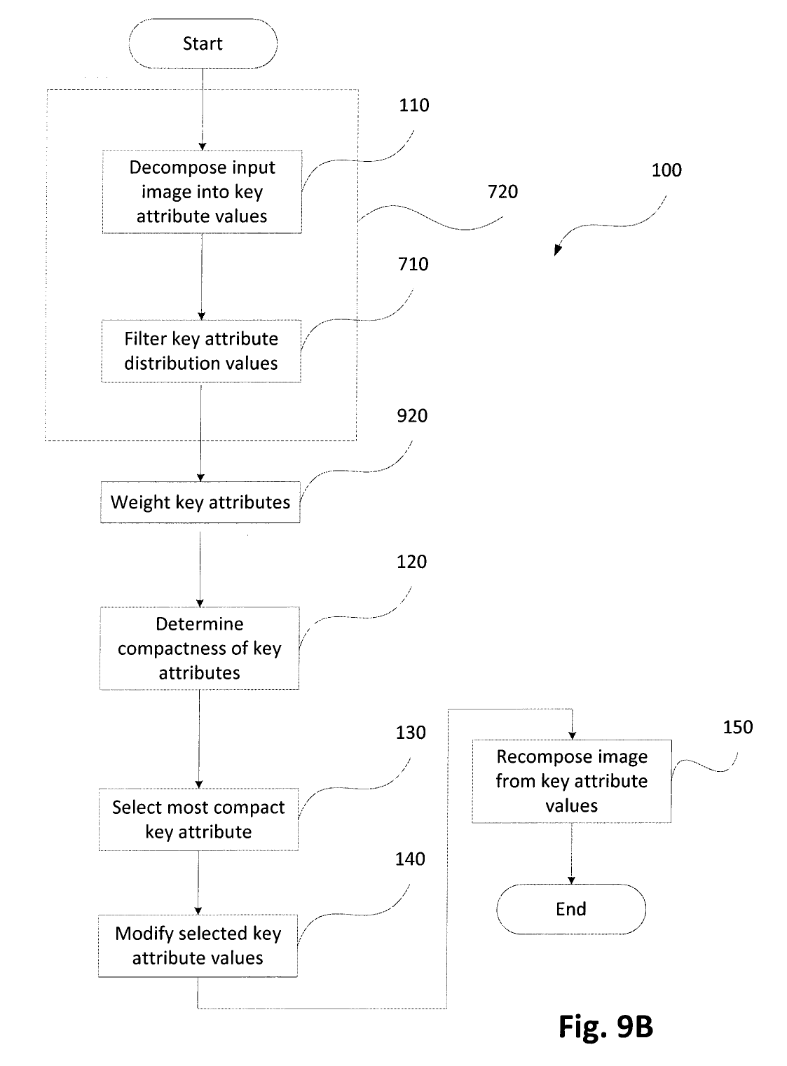

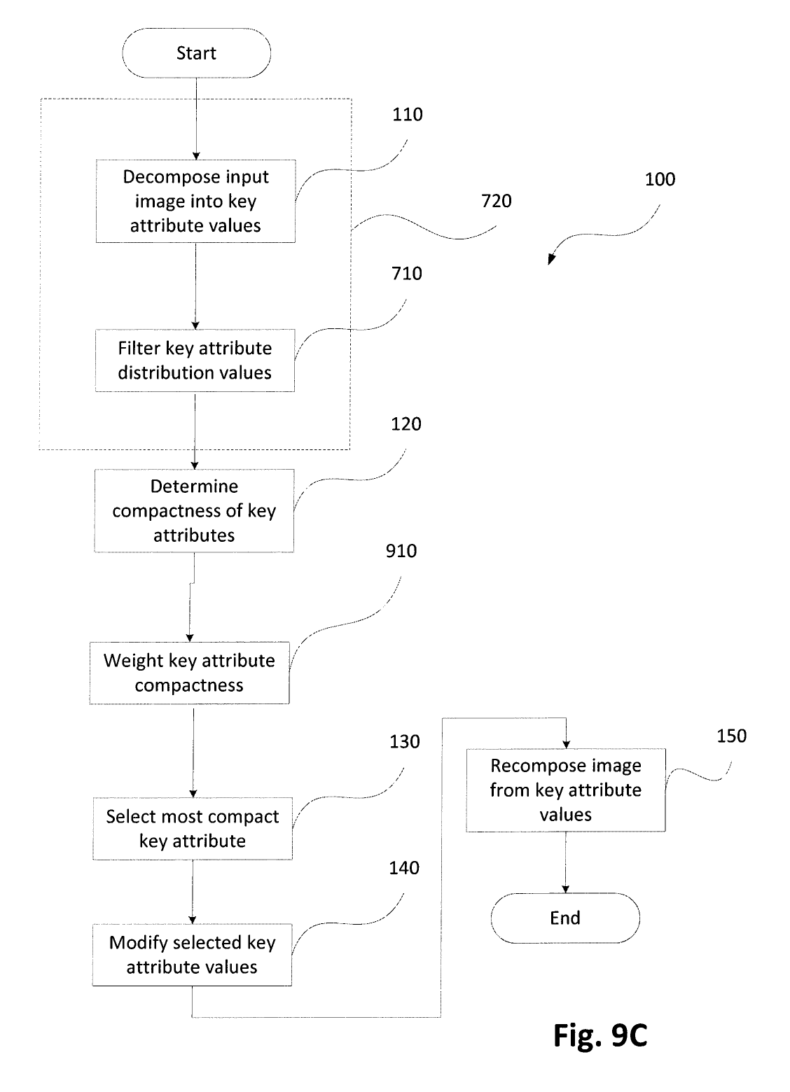

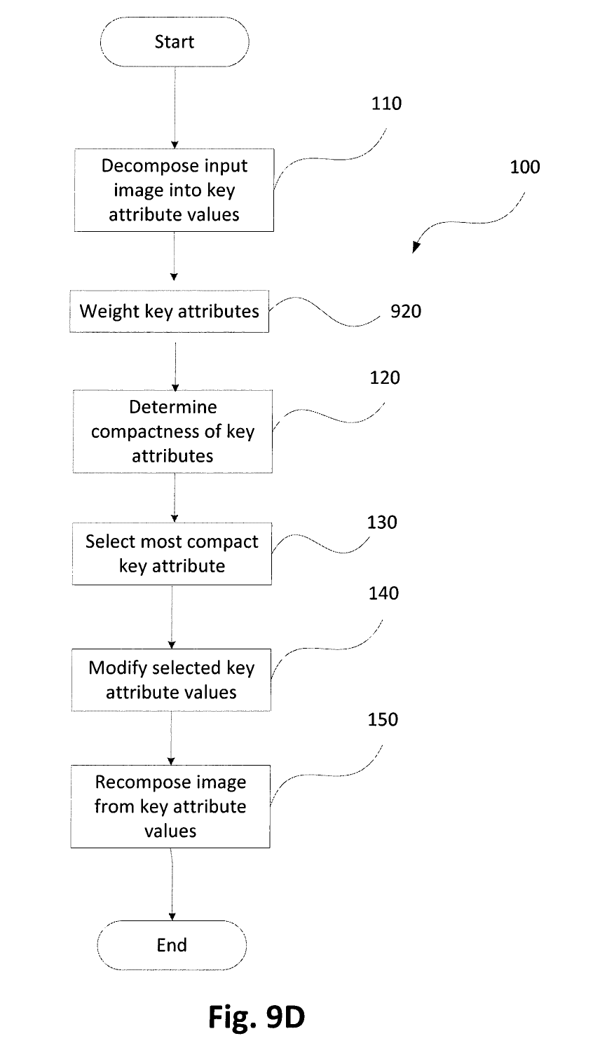

In one implementation, the distribution values associated with each of the key attributes may be weighted by predetermined weights depending on the selected key attribute distribution value. The compactness results may also be weighted by predetermined weights depending on the selected key attribute. FIG. 9A shows another alternative implementation of the method 100 where a compactness weighting step 910 is added between the compactness determination step 120 and the key attribute selection step 130. In particular, as the human visual system does not rely equally on all visual cues, it is, in some cases, desirable for image enhancement to weight the visual cues accordingly in order to ensure that it is not only the most compact key attribute of an image that is enhanced, but rather the most compact, perceptually relevant key attribute. Typically weighting is different depending on luminance or colour channels. For example, a weights ratio of 3:2:1 may be applied to the compactness determination for the CIE L, a, and b key attributes, respectively. Accordingly, the compactness of the CIE L attribute is given the highest weighting. Then at step 130, a most compact key attribute for modifying the input image is selected by the processor 1105 based on the applied weightings.

FIG. 9C shows still another alternative implementation of the method 100 where the compactness weighting step 910 is inserted after the compactness determination step 120 of the method 100 shown in FIG. 7. In this instance, the key attribute distribution values are filtered with a composition filter at step 710. Then at step 120, for each of the key attribute values remaining after step 710, a measure of compactness of the spatial localisation of the key attribute values is determined.

FIG. 9D shows still another alternative implementation of the method 100 where a key attribute weighting distribution step 920 is inserted between the decomposition step 110 and the compactness determination step 120. In this instance, at step 920, the processor 1105 applies a weighting to the key attribute distribution values determined at step 110. The weight ratio used at step 920 may be the weight ratio of 3:2:1 applied to values associated with each of the CIE L, a, and b key attribute values, respectively, as described above. For each of the weighted key attribute values, a measure of compactness of the spatial localisation of the key attribute values is determined in compactness determination step 120.

FIG. 9B shows still another alternative implementation of the method 100 where the key attribute weighting distribution step 920 is inserted after step 720 of the method 100 shown in FIG. 7. In this instance, the key attribute distribution values are filtered with a composition filter at step 710. Then at step 920, the processor 1105 applies a weighting to the key attribute distribution values remaining after filtering step 710. Again, the weight ratio used at step 920 may be the weight ratio of 3:2:1 applied to distribution values associated with each of the CIE L, a, and b key attribute values, respectively, as described above. Among the remaining key attribute distribution values, a most compact key attribute for modifying the input image is selected by the processor 1105 in key attribute selection step 130 as described above.

For a number of images, it is likely that more than one key attribute will be compact.

Several key attributes will typically have comparable compactness. In this instance, the key attribute to be modified may be selected not on numerical grounds alone but also taking image characteristics into account. For example, an image decomposed into CIE L, a, b, and sharpness shows that the compactness value for sharpness and CIE a are identical within 10%, with sharpness being the most compact of the two attributes. However, in accordance with the example, image metadata indicates that ISO speed of the camera 1127 at the time of capturing the image was set to 1600 (i.e., this is a noisy image). Increasing sharpness in a noisy image may decrease perceived quality of the image. Accordingly, instead of modifying a numerically most compact key attribute, a second most compact key attribute, whose numerical compactness value is very close to the most compact attribute, is selected instead.

The determination of compactness and the selection of a key attribute with the most compactness may not guarantee that the input image is compact according to the key attributes. As such, in one implementation, a predetermined threshold of compactness below which the result of the modification step 140 is null, is predetermined Such a predetermined threshold may be specified for each of the predetermined key attributes, for example, based on relative importance of the predetermined key attributes. In such an implementation, the processor 1105 may perform the step of comparing the compactness of each predetermined key attribute with the predetermined threshold to determine an amount of modification to be performed on that key attribute at step 140. Such a threshold of compactness prevents the method 100 from becoming a global enhancement method with the associated shortcomings.

As an example, if Xa, Xb, and XL represent threshold compactness values for which, should any of the CIE L, a, or b key attributes be the most compact key attribute according to the compactness calculation step 120, then the key attributes may be used in the modification step 140. If a compactness value falls below the compactness value, Xb, but remains above the compactness values Xa and XL, then CIE a or L is considered for modification if either of the CIE a or L attributes was calculated as the most compact key attribute. However, if the compactness determination step 120 returns CIE b as the most compact key attribute, then no modification occurs at step 140. Continuing the example, if the compactness value falls below the compactness values Xa and Xb, but remains above the compactness value XL, then the key attribute, CIE L, is considered for modification if the CIE L key attribute was determined to be the most compact key attribute at step 130. However, if the compactness determination step 120 returns CIE a or b as the most compact key attributes, then no modification would occur at step 140. Finally, if the determined compactness falls below the compactness values XL, Xa, and Xb, none of CIE L, a, or b key attributes are modified at step 140, regardless of the determined compactness of the CIE L, a, or b key attributes. The example above using three key attributes may be readily extended other key attributes. The relationship between the threshold compactness values, Xa, Xb, and XL, may also be altered depending on the implementation.

In a standard imaging workflow of scene—camera 1127—computer module 1101—printer 1115, an image may potentially be modified more than three times, resulting in over-enhancement and associated artefacts. To prevent such over-enhancement and artefacts, an image may be “tagged” to signify that the above methods have been applied to the image. The image may be tagged by, for example, setting and modifying a value in metadata of the image. When such an image is processed in accordance with the above methods, a check for the tag may be made and if found, no modification is performed in step 140. Accordingly, in one implementation, the method 100 is executed depending upon the presence of a tag in the image signifying that a modification has been previously applied. Similarly, in one implementation, a selected attribute may be modified depending upon the presence of a tag signifying that a modification has been previously applied.

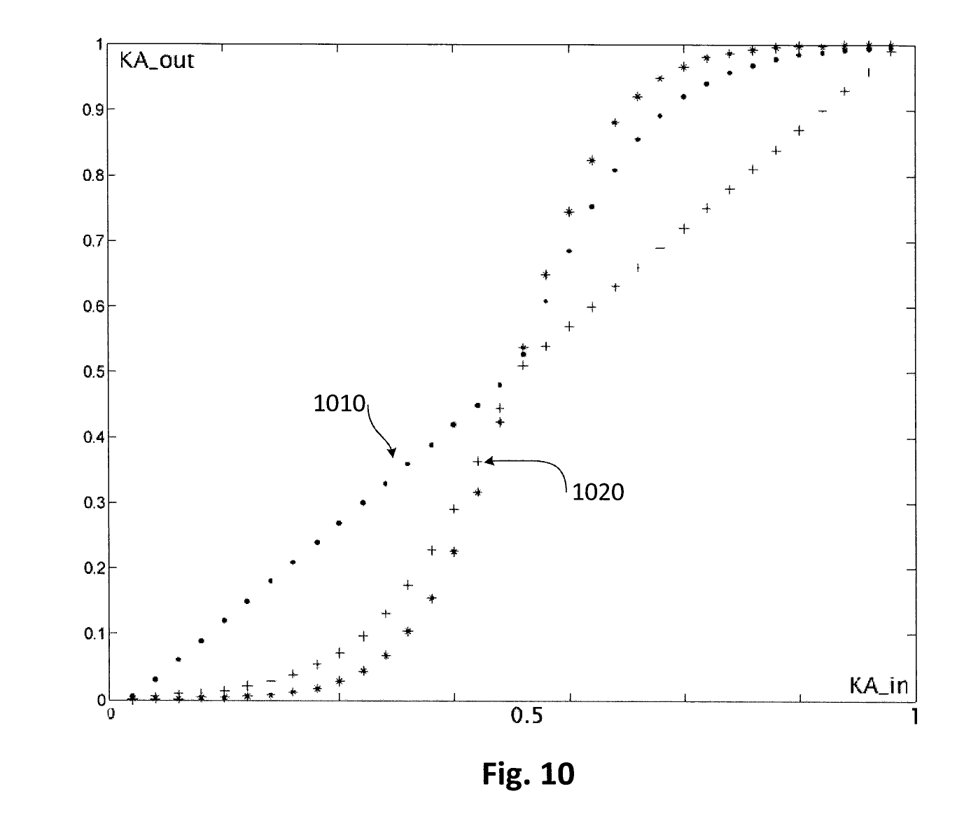

FIG. 10 shows alternative key attribute modification function curves. As seen in FIG. 10, for the curve 1010 only high values of key attributes are increased and low values of key attributes remain the same 1010. In another instance, for the curve 1020 only low values of key attributes are decreased, while other key attributes remain the same. Such one-sided modifications are more conservative, thus less prone to generating artefacts. In addition, such a one-sided modification may be used when either low or high values of the key attributes are close to clipping, as modifying the key attributes may create artefacts without providing a noticeable enhancement.

### INDUSTRIAL APPLICABILITY

The arrangements described are applicable to the computer and data processing industries and particularly for the image processing.

The foregoing describes only some embodiments of the present invention, and modifications and/or changes can be made thereto without departing from the scope and spirit of the invention, the embodiments being illustrative and not restrictive. For example, as described above, the method 100 may be implemented as one of more software code modules of the software application program 1133 resident on the hard disk drive 1110 and being controlled in its execution by the processor 1105 of the computer module 1101. Alternatively, the method 100 may be implemented as one or more software code modules of a software application program resident within a memory of the camera 1127 and being controlled in its execution by a processor of the camera 1127.

In the context of this specification, the word “comprising” means “including principally but not necessarily solely” or “having” or “including”, and not “consisting only of”. Variations of the word “comprising”, such as “comprise” and “comprises” have correspondingly varied meanings.

The claims defining the invention are as follows:

1. A method of modifying perceptual quality of an image, said method comprising:
determining, for each of a plurality of predetermined attributes, distribution values for that attribute, the distribution values being determined from a spatial distribution of the attribute across the image;
determining compactness of the distribution values for each of the attributes, said compactness being a measure of spatial localisation of the distribution values for the respective attribute;
selecting an attribute from the plurality of predetermined attributes based on the determined compactness of the respective distribution values;
modifying the selected attribute in a part of the image, so as to modify the perceptual quality of the image; and
storing the image, according to the modified attribute, in a computer readable storage medium.

2. The method of claim 1, further comprising increasing the value of the selected attribute in areas of the image where the selected attribute is compact.

3. The method of claim 1, further comprising decreasing the value of the selected attribute in areas of the image where the selected attribute is not compact.

4. The method of claim 1, further comprising increasing the value of the selected attribute in areas of the image where the selected attribute is compact and decreasing the value of the selected attribute in areas where the selected attribute is not compact.

5. The method of claim 1, further comprising comparing the compactness of the attribute with a predetermined threshold to determine an amount of the modification.

6. The method of claim 1 further comprising tagging the image to signify the method has been applied.

7. The method of claim 1, where the method is executed depending upon the presence of a tag signifying that a modification has been previously applied.

8. The method of claim 1, where the selected attribute is modified depending upon the presence of a tag signifying that a modification has been previously applied.

9. The method of claim 1, further comprising filtering the distribution values by location.

10. The method of claim 1, further comprising filtering the distribution values by a size.

11. The method of claim 1, further comprising weighting the distribution values by predetermined weights depending on the selected attribute.

12. The method of claim 1, further comprising weighting the compactness results by predetermined weights depending on the selected attribute.

13. A system for modifying perceptual quality of an image, said system comprising:
a memory for storing data and a computer program;
a processor coupled to said memory for executing said computer program, said computer program comprising instructions for:
determining, for each of a plurality of predetermined attributes, distribution values for that attribute, the distribution values being determined from a spatial distribution of the attribute across the image;
determining compactness of the distribution values for each of the attributes, said compactness being a measure of spatial localisation of the distribution values for the respective attribute;
selecting an attribute from the plurality of predetermined attributes based on the determined compactness of the respective distribution values;
modifying the selected attribute in a part of the image, so as to modify the perceptual quality of the image; and
storing the image, according to the modified attribute, in a computer readable storage medium.

14. An apparatus for modifying perceptual quality of an image, said apparatus comprising:
means for determining, for each of a plurality of predetermined attributes, distribution values for that attribute, the distribution values being determined from a spatial distribution of the attribute across the image;
means for determining compactness of the distribution values for each of the attributes, said compactness being a measure of spatial localisation of the distribution values for the respective attribute;
means for selecting an attribute from the plurality of predetermined attributes based on the determined compactness of the respective distribution values;
means for modifying the selected attribute in a part of the image, so as to modify the perceptual quality of the image; and
means for storing the image, according to the modified attribute, in a computer readable storage medium.

15. A computer readable storage medium having a program recorded there for modifying perceptual quality of an image, said program comprising:
code for determining, for each of a plurality of predetermined attributes, distribution values for that attribute, the distribution values being determined from a spatial distribution of the attribute across the image;
code for determining compactness of the distribution values for each of the attributes, said compactness being a measure of spatial localisation of the distribution values for the respective attribute;
code for selecting an attribute from the plurality of predetermined attributes based on the determined compactness of the respective distribution values;
code for modifying the selected attribute in a part of the image, so as to modify the perceptual quality of the image; and
code for storing the image, according to the modified attribute, in a computer readable storage medium.
